(19) United States
(12) Patent Application Publication
(10) Pub. No.: US 2012/0124951 A1
(43) Pub. Date: May 24, 2012

(54) AIR DUCT SCREEN AND METHOD OF USE

(75) Inventor: Hugh Michael Miskel, Marietta, GA (US)

(73) Assignee: MOUNTAIN VIEW PROMOTIONS, INC., Marietta, GA (US)

(21) Appl. No.: 13/300,043

(22) Filed: Nov. 18, 2011

Related U.S. Application Data
(60) Provisional application No. 61/415,075, filed on Nov. 18, 2010.

(51) Int. Cl. B01D 46/00; B23P 11/00

(52) U.S. Cl. 55/500; 55/511; 55/504; 29/428

(57) ABSTRACT

A duct screen mountable in an air duct for retaining objects which pass through an associated register, the screen having a filtering base having a plurality of holes and a frame to hold the filtering base in place within the air duct.

### CROSS-REFERENCE TO RELATED APPLICATION

This application claims benefit of copending U.S. provisional patent application No. 61/415,075, filed Nov. 18, 2010, and commonly assigned to the assignee of the present application, the disclosure of which is incorporated by reference in its entirety herein.

### FIELD

The present disclosure relates to an apparatus for air duct registers for impeding objects passing into or crawling out of an air duct.

### BACKGROUND

Most commercial and residential buildings have ducts which provide routes for air circulation powered by heating, ventilation and air conditioning (“HVAC”) units. The air ducts are located on the floor, in walls and in the ceiling. Most ducts have a cover, usually called a register, covering the opening in the floor, wall or ceiling, which, in part, helps to direct air into the room in a particular or general direction. The register typically has a series of slats or openings to direct the air. Registers may also have ornamental patterns of openings for aesthetic reasons. For ducts which are located in the floor, the openings in the register can often serve as a place where small insects can crawl or objects can irretrievably fall through the register into the air duct. Depending on the angle of the duct work, objects may travel down the air duct into the HVAC unit, which may cause damage or blockage.

It would be desirable to have an apparatus which could block the passage of small objects falling through a register from entering the duct work. It would also be desirable for such an apparatus to be easily removable so that the objects can be retrieved or for the device to be cleaned. It would further be desirable to have an apparatus which would have the retaining aspect be well below the surface of the register.

### SUMMARY

One exemplary embodiment of the present disclosure provides an air duct screen have a basket-like filtering base have a central opening and a frame surrounding or partially surrounding the central opening. The filtering base may be cut from a single sheet of screen material and the frame can include a flange of that material, which can be folded around the filtering base. The filtering base can have walls and a mesh structure. The air duct screen can impede the passage of debris (such as objects, insects, or animals) from passing down into the air duct. Should debris pass through the air duct register (e.g. a floor register), the debris can be retained in the basket-like feature of the air duct screen.

One aspect of the present disclosure provides an air duct screen mountable in an air duct for retaining objects, the duct screen comprising a filtering base made of a material adapted to permit air to flow therethrough and having side wall portions, a bottom portion, a chamber formed therein adapted to retain objects and a top opening, and, a frame associated with the side walls to hold the filtering base in place within the duct.

Another aspect of the present disclosure provides a vent screen system to be mounted in a duct opening of a floor, wall or ceiling for retaining debris, comprising a filtering base having sidewalls, a bottom wall and an opening, a frame at least partially surrounding the opening to hold the filtering base in place within the duct, and a register.

Another aspect of the present disclosure provides a method for retaining objects passing through an air duct register into an air duct, comprising providing an air duct screen comprising a filtering base made of a material adapted to permit air to flow therethrough and having side wall portions, a bottom portion, a chamber formed therein adapted to retain objects and a top opening and a frame associated with the side walls to hold the filtering base in place within the duct; inserting the screen into the duct; and placing a register over the duct to over the opening.

Other features will become apparent upon reading the following detailed description of certain exemplary embodiments, when taken in conjunction with the appended claims.

### BRIEF DESCRIPTION OF THE DRAWINGS

The drawings disclose exemplary embodiments in which like reference characters designate the same or similar parts throughout the figures of which:

FIG. 1 is a perspective view of one exemplary embodiment of an air duct screen showing filtering base and the frame;

FIG. 2 is a perspective view illustrating the installation of the air duct screen shown in FIG. 1 in an air duct;

FIG. 3 is a perspective view of another exemplary embodiment of an air duct screen showing filtering base and the frame;

FIG. 4 is a perspective view of one exemplary embodiment illustrating the installation of the air duct screen shown in FIG. 3 in an air duct;

FIG. 5 is a perspective view of another exemplary embodiment of an air duct screen;

FIG. 6A is a perspective view of another exemplary embodiment of an air duct screen;

FIG. 6B is a perspective view of the edge of a screen according to one exemplary embodiment; and

FIG. 7 is a perspective view of another exemplary embodiment of an air duct screen placed in an air duct.

### DETAILED DESCRIPTION

One exemplary embodiment of the present disclosure provides an air duct screen 12 that is capable of impeding the passage of insects, animals or objects through a duct 10. For the purposes of the present description, the term “object” will be used and includes, but is not limited to insects, animals, inanimate objects, dirt, debris, and the like. Air duct screen 12 can block objects from passing into the air duct 10.

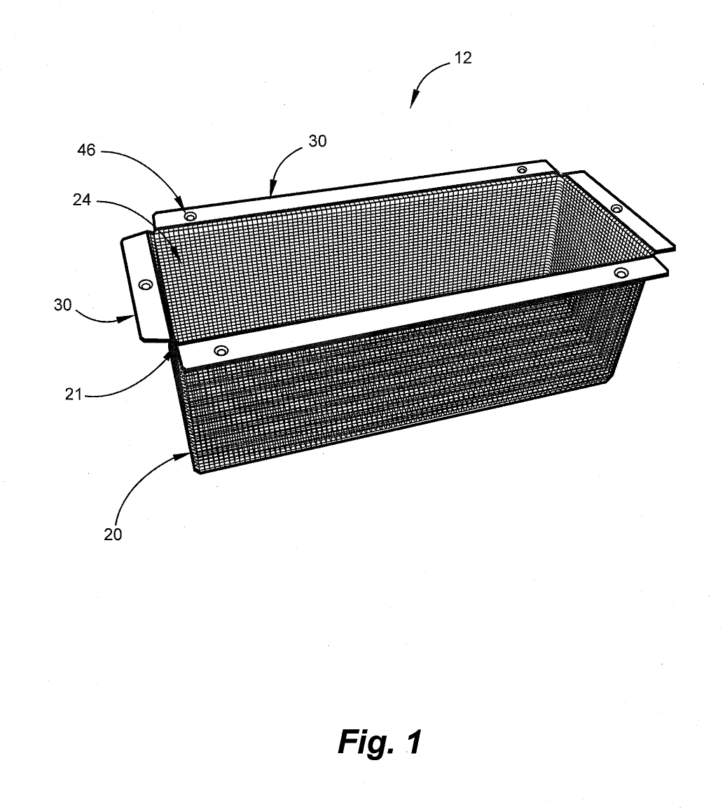

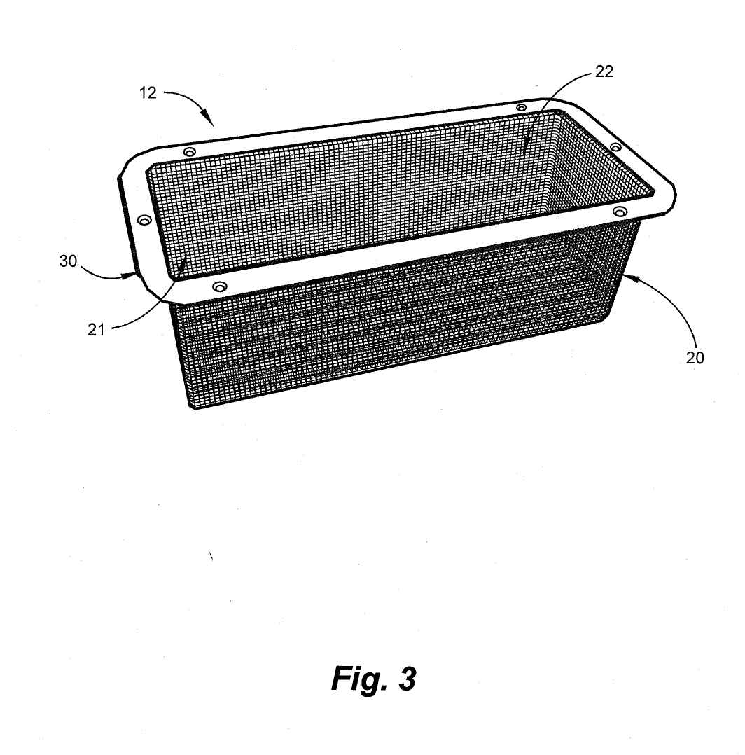

FIGS. 1 and 3 show perspective views of air duct screen 12 according to first and second exemplary embodiments in which air duct screen 12 comprises a filtering base 20 having an object-retaining chamber 21 having a central opening 22 and a frame 30 at least partially surrounding central opening 22. Filtering base 20 may be cut as a single shape from a single sheet of material, and frame 30 can include a flange from this single sheet which can be folded around filtering base 20. Filtering base 20 can have a mesh, grid, net, web or other structure capable of permitting substantially unrestricted airflow yet able to retain small objects. The fineness or coarseness of the structure can be chosen for the particular use. For certain uses, it may be desirable to have the mesh size be sufficiently coarse so as to not trap dust, which could clog the air duct and reduce air flow and require more frequent cleaning of the filter. Filtering base 20 also includes walls 24. As shown in FIG. 3, frame 30 may have a reasonably smooth exterior so that air duct screen 12 can be without sharp edges, a feature which facilitates better handling, storage, and transportation. Frame 30 and filtering base 20 are illustratively shown in the shape of a rectangular, but can be any suitable geometric, irregular or decorative shape, such as, but not limited to, square, oval, hexagon, octagon, circle, star, and the like. In certain exemplary embodiments, the filtering base 20 may be made of generally rigid material, or may have some flexibility. In certain exemplary embodiments the filtering base may be made of a fabric or fabric-like material which may have substantial flexibility.

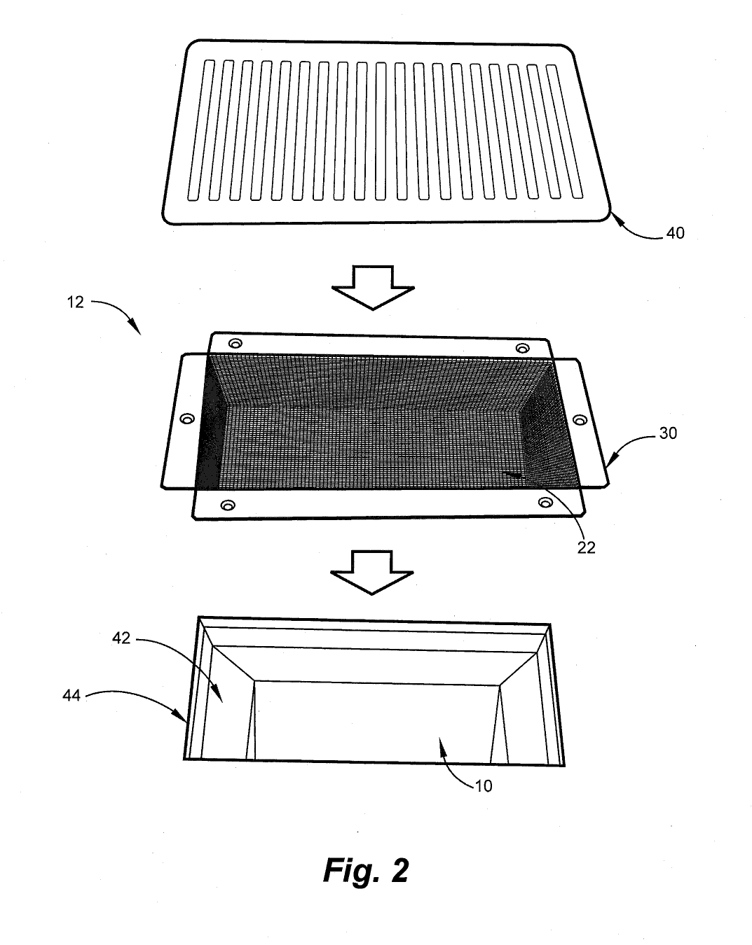

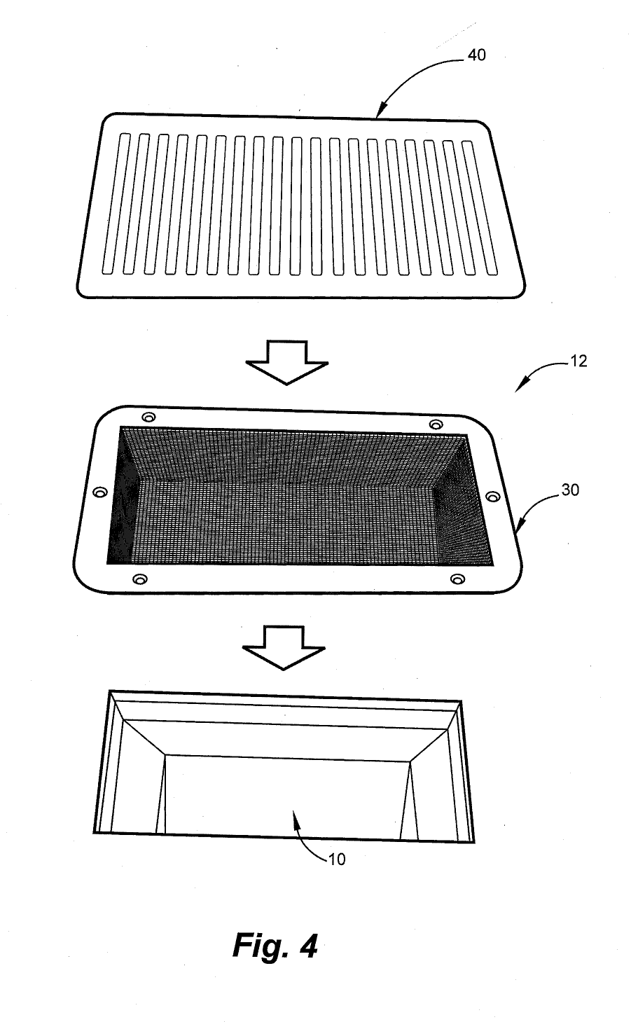

FIGS. 2 and 4 schematically show exemplary embodiments of an air duct 10, register 40 and an air duct screen 12. Air duct screen 12 can be installed in the opening 42 (defined by an edge 44 of the floor, wall or ceiling in which an opening has been cut) of duct 10 by fitting frame 30 over edge 44 and inserting the filtering base 20 into the air duct 10. Register 40 may be placed over frame 30. Optionally, frame 30 may include holes 46 which may receive screws or other fasteners which may be used to mount register 40 and frame 30 to the surface around the air duct opening 42. Objects falling through the register 40 will be retained in the chamber 21.

The present disclosure also provides a method for impeding the passage of objects through a duct. In one exemplary embodiment a method can include providing a filtering base 20 of air duct screen 12 as described herein. The flange of frame 30 can be fitted over the edge 44 of the duct opening 42. The flange of frame 30 optionally can be fixed to the surface by suitable fasteners, e.g., screws, nails, or the like. In certain embodiments, additional holes can be place in walls 24 and through duct 10 for additional support. In operation the screen 12 can be removed from the air duct 12 as needed to retrieve and remove objects from the chamber 21.

In another exemplary embodiment, the peripheral edge of frame 30 is rigidly secured to filtering base 20 by any convenient means, such as by welding, brazing, adhesive or the like. In this embodiment, there is no relative movement of filtering base 20 and frame 30, so the air duct screen 12 can be literally characterized as an integral structure with no moving parts. The lack of moving parts can simplify mass production and add to longevity.

The shape and dimensions of air duct screen 12 can vary depending upon the intended location of use. One exemplary set of dimensions for air duct screen 12 is as follows: The outside dimensions of frame 30 are approximately 5¾ inches by 11¾ inches. The thickness of filtering base 20 can be approximately ¼ to ¾ inch. The width of mesh is approximately 1/16 inch greater than the screen thickness. In certain embodiments, the shape and dimensions of air duct screen 12 should be selected so to allow register 40 to be inserted into air duct screen 12.

The size of the filtering holes of base 20 can be varied to control the size of debris passing through filtering base 20 and can be sized filtering based on the desired selectivity of the filtering base 20. The mesh of filtering base 20 may be about ⅛ inch to two inches thick, and is usually in the range of about ⅛ inch to ¼ inch thick. In one exemplary form, the filtering base 20 comprises of walls 24 formed of 3 mil stock aluminum, although the walls can be somewhat thinner or thicker if desired. Also, other materials may be used, such as steel, plastics, such as, but not limited to Fiberglas-reinforced, or other composite materials. The diameter of the holes in filtering base 20 also can vary from about ⅛ inch to ¼ inch. Alternatively, other diameter holes may be formed. In the claims which follow, “dimension” or “width” or “opening size” refers to this smaller dimension in openings, or to minimum dimensions from wall to wall of rectangular openings.

The color can be varied to create a desired look and feel. In certain specific embodiments, the filtering base and frame may be colored so to minimize the visual attention or distraction. For example, a dark color may help hide the duct from being seen through the register.

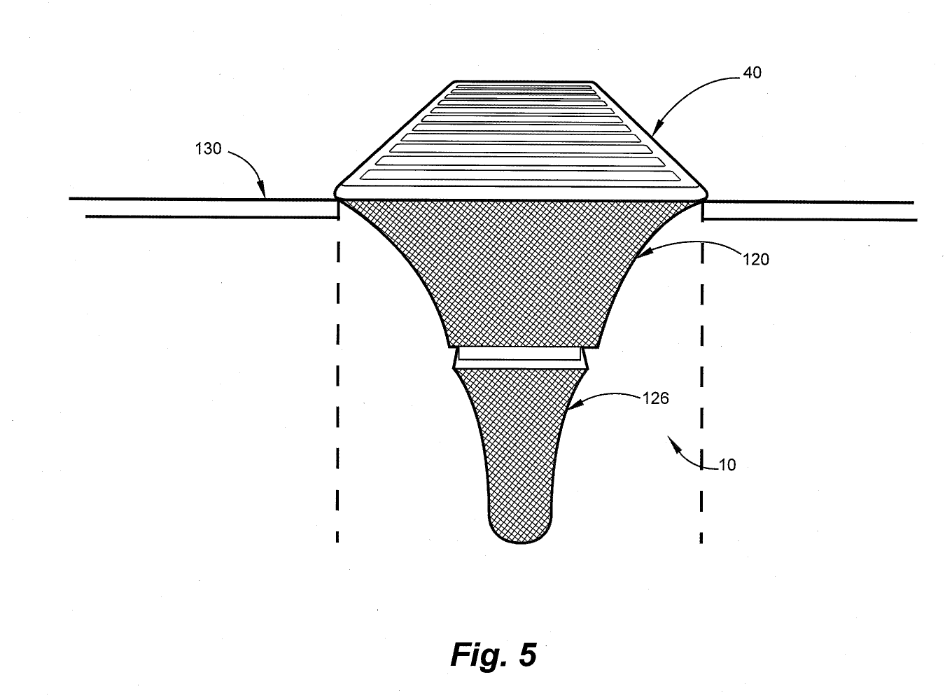

FIG. 5 shows an exemplary embodiment in which base 120 is made of a softer material that can form a net-like structure secured to register 40, which can rest on surface 130. At the end of base 120 away from register 40, there can be catch section 126 of mesh material. Catch section 126 can add weight to the net, which can help keep the netting open so that objects can be retained.

A feature of the presently disclosed screen is that the chamber 21 allows for a number of objects to be collected over time which can be removed at the user's convenience, yet permit passage of air through the screen 12.

The air duct screen described above can be inexpensively manufactured with or without the use of fasteners. Because it is possible to form most or all of the component parts of plastic, or metal or metalized plastic the cost of manufacture of the register assembly is reduced which also results in a reduction in cost to the purchaser.

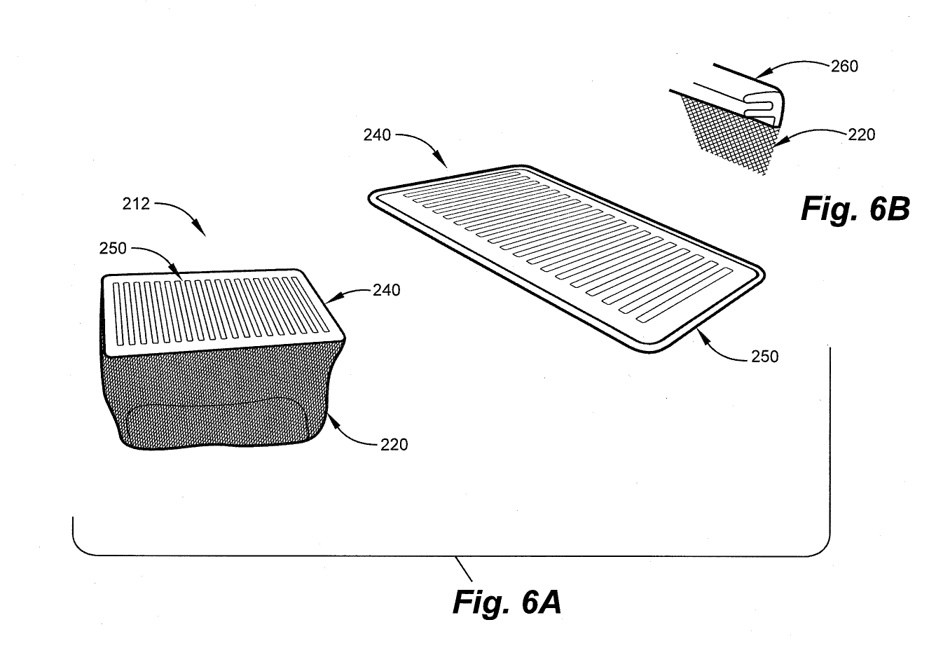

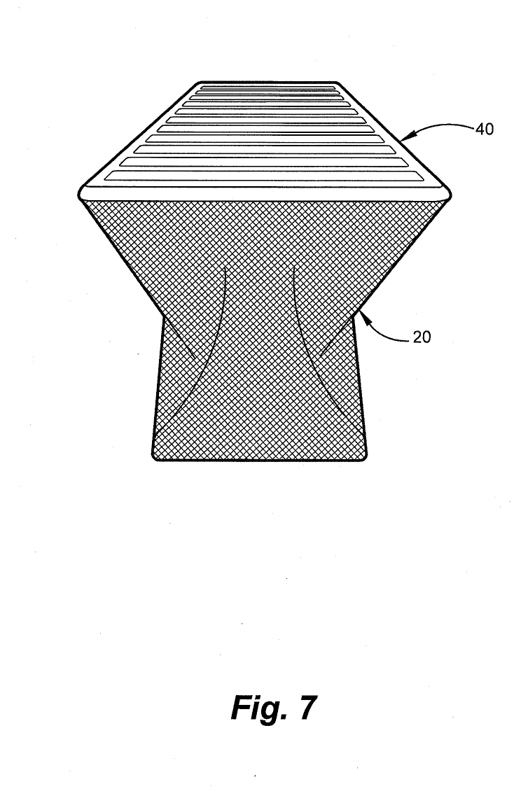

FIGS. 6 and show exemplary embodiments of an air duct screen 212 constructed without a frame in which filtering base 20 is a mesh material that can be anchored to the side edges 250 of register 240. In such embodiments, there can be rubber channel or seal 260 to hold the mesh material in place around register 40. Register 40 together with the screen 212 can then be placed in the duct.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

While the apparatus and methods have been described in connection with specific embodiments, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

As used in the specification and the appended claims, the singular forms “a,” “an” and “the” include plural referents unless the context clearly dictates otherwise.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods, equipment and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods, equipment and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts.

I claim:

1. An air duct screen mountable in an air duct for retaining objects, the duct screen comprising:
(a) a filtering base made of a material adapted to permit air to flow therethrough and having side wall portions, a bottom portion, a chamber formed therein adapted to retain objects and a top opening; and,
(b) a frame associated with the side walls to hold the filtering base in place within the duct.

2. The screen as claimed in claim 1, wherein the screen has a non-planar shape.

3. The screen as claimed in claim 1, further comprising a register adapted to be mounted over the frame.

4. The screen as claimed in claim 1, wherein the side walls form a rectangular shape.

5. The system as claimed in claim 1, wherein the register is a planar plate.

6. The system as claimed in claim 1, wherein the register is over the opening and secured to the frame.

7. A vent screen system to be mounted in a duct opening of a floor, wall or ceiling for retaining debris, comprising:
(a) a filtering base having sidewalls, a bottom wall and an opening;
(b) a frame at least partially surrounding the opening to hold the filtering base in place within the duct; and
(c) a register.

8. A method for retaining objects passing through an air duct register into an air duct, comprising:
(a) providing an air duct screen comprising a filtering base made of a material adapted to permit air to flow therethrough and having side wall portions, a bottom portion, a chamber formed therein adapted to retain objects and a top opening and a frame associated with the side walls to hold the filtering base in place within the duct;
(b) inserting the screen into the duct; and
(c) placing a register over the duct to over the opening.

9. The method as claimed in claim 8, wherein the screen has a filtering base and the filtering base is shaped as a basket.

10. The method as claimed in claim 9, wherein the air duct screen has a non-planar shape.

11. The method as claimed in claim 9, wherein the screen further comprises a frame for maintaining the filtering base in place within the duct.
